(19) United States
(12) Patent Application Publication
(10) Pub. No.: US 2006/0092183 A1
(43) Pub. Date: May 4, 2006

(54) System and method for setting brightness uniformity in an active-matrix organic light-emitting diode (OLED) flat-panel display

(75) Inventor: Paul R. Malmberg, Pittsburgh, PA (US)

Correspondence Address: DICKSTEIN SHAPIRO MORIN & OSHINSKY LLP, 2101 L Street, NW, Washington, DC, 20037, US

(73) Assignee: Amedeo Corporation

(21) Appl. No.: 11/038,518

(22) Filed: Jan. 21, 2005

Related U.S. Application Data
(63) Continuation-in-part of application No. 10/970,382, filed on Oct. 22, 2004.

(51) Int. Cl. G09G 5/10

(52) U.S. Cl. 345/690

(57) ABSTRACT

A brightness calibration system for and method of setting brightness uniformity in a video display, such as an active-matrix organic light-emitting diode (OLED) flat-panel display. The brightness calibration system of the present invention includes an OLED display assembly that further includes a display control circuit, an active-matrix display, a DC power supply; and a measurement circuit. In a measurement mode, the brightness calibration system and method of the present invention subjects a video display to a brightness calibration operation that alternately measures the output light intensity of every pixel for a given input voltage and saves the measured light intensity in memory. In a display mode, the brightness calibration system and method of the present invention applies a corrective voltage to each pixel, in real time, so that each pixel has substantially the same output light intensity as its neighboring pixel.

### CROSS-REFERENCES TO RELATED APPLICATIONS

This is a continuation-in-part of application Ser. No. 10/970,382, filed Oct. 22, 2004, the entirety of which is incorporated by reference herein.

### FIELD OF THE INVENTION

The present invention relates to an organic light-emitting diode (OLED) flat-panel display. In particular, this invention relates to a system for and method of providing brightness uniformity in an active-matrix OLED flat-panel display.

### BACKGROUND OF THE INVENTION

The circuit structure of an active-matrix OLED display, in which a plurality of pixels is arranged in rows and columns, is widely known. Each pixel includes two thin film transistors (TFTs), i.e., an addressing (or switching) transistor and a driving (or power) transistor, a storage capacitor, and an OLED device.

As is well known, in the conventional active-matrix OLED panel circuit, a scan line (row line) is selected, a video signal loaded in a data line (column line) is input to the driving transistor via the addressing transistor to control the current through the OLED device. The video signal is stored in the storage capacitor for the duration of one frame.

TFTs used in active-matrix OLED display panels are formed by use of amorphous silicon, polysilicon, or cadmium selenide (CdSe) through manufacturing processes such as photolithography or evaporation by use of a shadow mask technology. Threshold voltage variation in such a TFT, which may be caused by variations in the manufacturing process, leads to current non-uniformities between pixels and non-uniform brightness. These problems are not significant in small-screen applications, such as flat-panel displays in watches, telephones, laptop computers, pagers, mobile phones, calculators, and the like. However, in a large-screen display application, such as a flat-panel television, the display undergoes more serious threshold non-uniformities, and the quality of the display, such as brightness uniformity, is noticeably degraded.

The light output depends on several factors—(1) the uniformity of the power transistors at the time of manufacture, (2) the uniformity of the power transistors as they age, and (3) the stability of the medium itself that is being driven. Therefore, there is a technical challenge in ensuring that the power transistors that drive the OLEDs are uniform and, secondly, if they are not uniform, there is a technical challenge in correcting the non-uniformity. What is needed is a way to compensate the active-matrix power transistors so that they are uniform and, thus, the brightness of the active-matrix OLED display is uniform from pixel-to-pixel across the display.

An example circuit for compensating an active-matrix OLED display is found in reference to U.S. Pat. No. 6,414,661, entitled, “Method and apparatus for calibrating display devices and automatically compensating for loss in their efficiency over time.” The '661 patent describes a method and associated system that compensates for long-term variations in the light-emitting efficiency of individual OLED in an OLED display device, calculates and predicts the decay in light output efficiency of each pixel, based on the accumulated drive current applied to the pixel, and derives a correction coefficient that is applied to the next drive current for each pixel. The '661 patent further provides a method for calibrating a display device formed of an array of individually adjustable discrete light-emitting devices (pixels) by use of a camera that has an array of radiation sensors or a single photodetector.

While the '661 patent describes a suitable method of providing pixel drive current compensation, it does so by using a complex process of capturing images of each pixel with a camera system. What is needed is a way to provide pixel-by-pixel compensation to overcome brightness non-uniformity without a complex system.

It is an objective of the invention to provide an active-matrix OLED display that has uniform brightness from pixel-to-pixel across the full area of the display by overcoming brightness non-uniformity caused by irregularities of the manufacturing process or of the light emissive material itself.

It is another objective of this invention to provide a simplified system for and method of calibrating the brightness of a flat-panel on a pixel-by-pixel basis.

### SUMMARY OF THE INVENTION

The present invention is a brightness compensation system for and method of providing brightness uniformity in an active-matrix OLED flat-panel display. The present invention anticipates the use of control and memory circuits built into the interface circuitry of an active-matrix display that uses a current-dependent, light-emitting medium to completely compensate for inconsistencies in the threshold voltage and gain of the active elements (thin film transistors), both in the display and in the peripheral row and column addressing circuits, and non-uniformities in the light emissive OLED elements, and so it is assured that each display element delivers the exact current at its output that is required by the brightness signal of the video input signal.

The brightness compensation system and method of the present invention subjects an active-matrix OLED display to a testing operation that alternately tests every pixel, detects its output current, which is an indicator of light output level, for a given input voltage, saves the output current value in memory, then applies a corrective voltage to each pixel, so that each pixel has the same light output as its neighboring pixel. The testing operation may be performed either one pixel at a time or multiple pixels at a time.

Other features and advantages of the present invention will become apparent from the following description of the invention which refers to the accompanying drawings.

### BRIEF DESCRIPTION OF THE DRAWINGS

FIG. 1 illustrates an active-matrix array, which is representative of an exemplary portion of a larger active-matrix OLED flat-panel display.

FIG. 2 shows a graph that illustrates example plots of the pixel light output intensity vs. the applied gate voltage of the power transistor, which determines the brightness of the pixel.

FIG. 3 illustrates a functional block diagram of a brightness calibration system for providing brightness uniformity within an active-matrix OLED flat-panel display in accordance with a first embodiment of the invention.

FIG. 4 illustrates a detailed functional block diagram of an OLED display assembly of the brightness calibration system of the present invention.

FIG. 5 illustrates a detailed functional block diagram of a measurement circuit of the brightness calibration system of the present invention.

FIG. 6 illustrates a flow diagram of a method of calibrating a video display to achieve uniform brightness by use of the brightness calibration system of the present invention.

### DETAILED DESCRIPTION OF THE PREFERRED EMBODIMENT

In the following detailed description, reference is made to various specific embodiments in which the invention may be practiced. These embodiments are described with sufficient detail to enable those skilled in the art to practice the invention, and it is to be understood that other embodiments may be employed, and that structural and logical changes may be made without departing from the spirit or scope of the present invention.

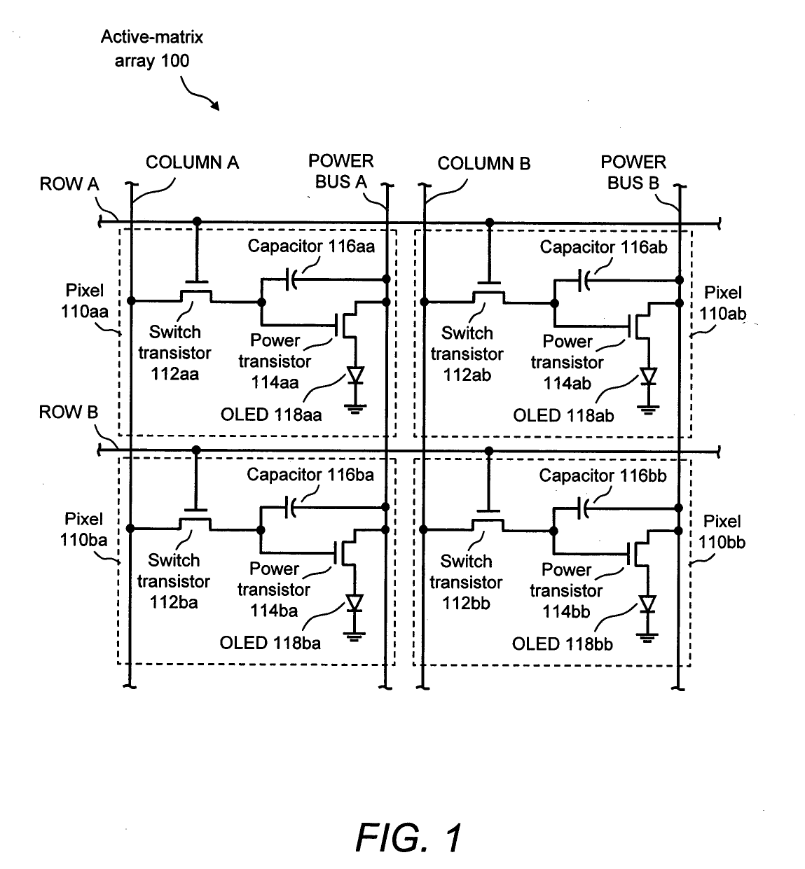

FIG. 1 illustrates an active-matrix array 100, which is representative of an exemplary portion of a larger active-matrix OLED flat-panel display. In this example, active-matrix array 100 is a 2×2 array of pixels 110, i.e., a pixel 110aa, a pixel 110ab, a pixel 110ba, and a pixel 110bb, which are addressed via pulsed signals applied to a ROW A and a ROW B and via voltage levels applied to a COLUMN A and a COLUMN B. Power is supplied to pixels 110aa, 110ab, 110ba, and 110bb via a POWER BUS A and a POWER BUS B. Each pixel 110 is formed by a standard active-matrix electrical circuit that includes a switch transistor 112, a power transistor 114, a capacitor 116, and an OLED 118. In this example, pixel 110aa includes a switch transistor 112aa, a power transistor 114aa, a capacitor 116aa, and an OLED 118aa; pixel 110ab includes a switch transistor 112ab, a power transistor 114ab, a capacitor 116ab, and an OLED 118ab; pixel 110ba includes a switch transistor 112ba, a power transistor 114ba, a capacitor 116ba, and an OLED 118ba; and pixel 110bb includes a switch transistor 112bb, a power transistor 114bb, a capacitor 116bb, and an OLED 118bb.

The arrangement of the electrical components of each pixel 110 is described with reference to pixel 110aa as follows. The gate of switch transistor 112aa is connected to ROW A, the source of switch transistor 112aa is connected to COLUMN A, and the drain of switch transistor 112aa is connected to the gate of power transistor 114aa. The drain of power transistor 114aa is connected to POWER BUS A and the source of power transistor 114aa is connected to the anode of OLED 118aa. The cathode of OLED 118aa is connected to ground. Lastly, one side of capacitor 116aa is connected at the node between the drain of switch transistor 112aa and the gate of power transistor 114aa. The opposing side of capacitor 116aa is connected to any fixed voltage node; in this example, capacitor 116aa is connected to POWER BUS A. The arrangement of the electrical components of pixels 110ab, 110ba, and 110bb is identical, except for their connections to their respective ROW, COLUMN, and POWER BUS.

The operation of each pixel 110 of active-matrix array 100 is described with reference to pixel 110aa as follows. A power supply voltage in the range of, for example, +5 to +20 volts is applied to POWER BUS A. To activate OLED 118aa, a steady-state voltage in the range of, for example, +2 to +15 volts, which corresponds to a desired brightness level, is applied at COLUMN A. Subsequently, a pulsed signal is applied to ROW A, which momentarily closes switch transistor 112aa and, thus, the voltage level at COLUMN A is transferred to the drain of switch transistor 112aa, and, subsequently to the gate of power transistor 114aa. As a result, power transistor 114aa is switched on, and the voltage present at POWER BUS A is transferred therethrough and activates OLED 118aa. Furthermore, as capacitor 116aa is connected between the gate power transistor 114aa and POWER BUS A, capacitor 116aa is charged with the voltage level present at COLUMN A. Subsequently, capacitor 116aa serves as a storage device for storing the voltage potential received from COLUMN A, even after the pulsed signal from ROW A is ended and switch transistor 112aa is opened. Via capacitor 116aa, a voltage remains upon the gate of power transistor 114aa and, thus, power transistor 114aa is held on, which in turn holds OLED 118aa in an active state, i.e., emitting light. Conversely, OLED 118aa is turned off when zero volts is applied to COLUMN A and, subsequently, when a signal pulse is applied at ROW A to switch off power transistor 114aa, which deactivates OLED 118aa, and to discharge capacitor 116aa. Zero volts is stored upon capacitor 116aa and, thus, power transistor 114aa is held off and OLED 118aa is held in the inactive state, even after the signal pulse at ROW A is ended and switch transistor 112aa is opened.

In like manner, OLED 118ab is turned on or off when a positive voltage or zero volts is applied, respectively, to COLUMN B, when a positive supply voltage is applied to POWER BUS B, and then when a signal pulse is applied at ROW A; OLED 118ba is turned on or off when a positive voltage or zero volts is applied, respectively, to COLUMN A, when a positive supply voltage is applied to POWER BUS A, and then when a signal pulse is applied at ROW B; and OLED 118bb is turned on or off when a positive voltage or zero volts is applied, respectively, to COLUMN B, when a positive supply voltage is applied to POWER BUS B, and then when a signal pulse is applied at ROW B.

Because power transistors 114aa, 114ab, 114ba, and 114bb are analog devices, the current flowing therethrough is dependant on the voltage that is applied to their gates, which is supplied via the COLUMN lines. Furthermore, the brightness of OLEDs 118aa, 118ab, 118ba, and 118bb is determined by the current supplied by power transistors 114aa, 114ab, 114ba, and 114bb, respectively. Consequently, the uniformity of the performance characteristics of power transistors 114aa, 114ab, 114ba, and 114bb directly impacts the brightness uniformity of OLEDs 118aa, 118ab, 118ba, and 118bb, with respect to one another.

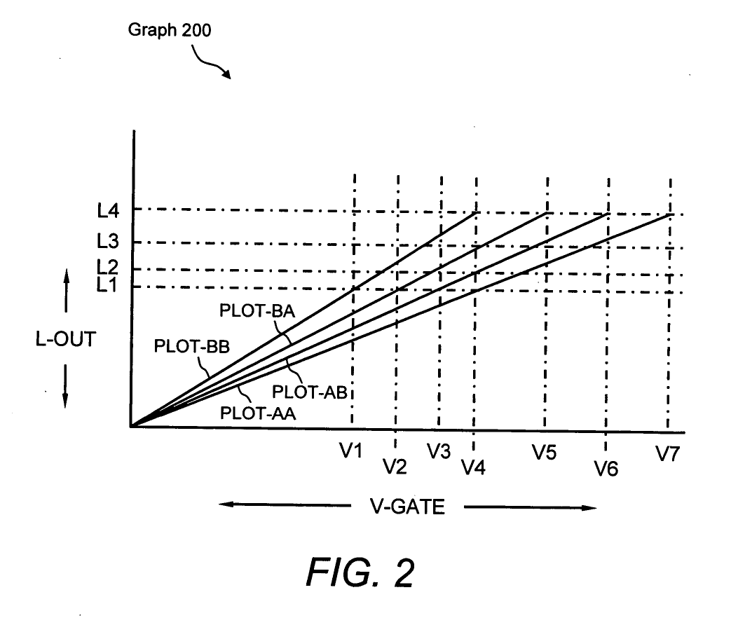

FIG. 2 shows a graph 200 that illustrates example plots of the pixel light output intensity (L-OUT) vs. the applied gate voltage of the power transistor (V-GATE), which determines the brightness of the pixel. More specifically and with reference to FIGS. 1 and 2, the L-OUT vs. V-GATE of OLEDs 118aa, 118ab, 118ba, and 118bb is, for example, a PLOT-AA, a PLOT-AB, a PLOT-BA, and a PLOT-BB, respectively. For the purpose of illustration, PLOT-AA, PLOT-AB, PLOT-BA, and PLOT-BB represent differing performance characteristics (not to scale) of pixels 110aa, 110ab, 110ba, and 110bb of active-matrix array 100. In this example, along the V-GATE axis of graph 200, V-GATE is increasing from V1 to V7. Along the L-OUT axis of graph 200, L-OUT is increasing from L1 to L4. PLOT-BB shows that OLED 118bb of pixel 110bb is the highest performing pixel by comparison and PLOT-AA shows that OLED 118aa of pixel 110aa is the lowest performing pixel by comparison. PLOT-AB and PLOT-BA perform at an intermediate level by comparison. More specifically, PLOT-BB shows that, at a given V-GATE, V4, OLED 118bb provides the highest L-OUT, L4, by comparison. By contrast, in order for OLED 118aa to achieve the same L-OUT, L4, which corresponds to the same brightness level as OLED 118bb, the V-GATE of OLED 118aa is set to a higher level, V7. Similarly, the V-GATE of OLED 118ab and OLED 118ba must be set to V6 and V5, respectively, in order to achieve the same L-OUT, L4, and, thus, the same brightness level as OLED 118bb, which is operating at V4.

There are two approaches to providing uniform brightness across an array of OLEDs that form a flat-panel display:
1. Determine the highest performing pixel (highest L-OUT, i.e., highest brightness level, for a given V-GATE) in the array and then adjust upward the V-GATE voltage of all the lesser performing pixels, until the L-OUT of all the lesser performing pixels matches the L-OUT of the highest performing pixel. For example, and with reference to FIGS. 1 and 2, if OLED 118bb (PLOT-BB) represents the highest performing pixel, which provides an L-OUT of L4 with V-GATE set at V4, then V-GATE for OLED 118aa (PLOT-AA) is set at V7, V-GATE for OLED 118ab (PLOT-AB) is set at V6, and V-GATE for OLED 118ba (PLOT-BA) is set at V5, in order to substantially achieve an L-OUT of L4.
2. Determine the lowest performing pixel (lowest L-OUT, i.e., lowest brightness level, for a given V-GATE) in the array and then adjust downward the V-GATE voltage of all the higher performing pixels, until the L-OUT of all the higher performing pixels matches the L-OUT of the lower performing pixel. The method assumes that the lower performing pixel is performing at an acceptable brightness level. For example, and with reference to FIGS. 1 and 2, if OLED 118aa (PLOT-AA) represents the lowest performing pixel, which provides an L-OUT of L1 with V-GATE set at V4, then V-GATE for OLED 118ab (PLOT-AB) is set at V3, V-GATE for OLED 118ba (PLOT-BA) is set at V2, and V-GATE for OLED 118bb (PLOT-BB) is set at V1, in order to substantially achieve an L-OUT of L1.

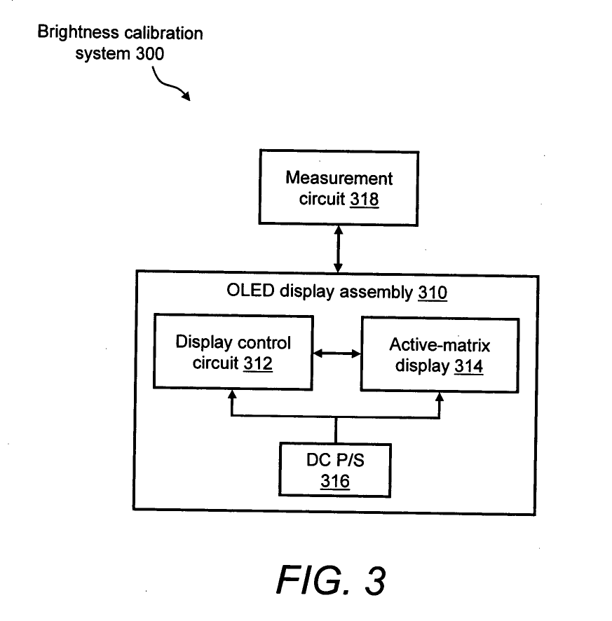

The first method of providing brightness uniformity, as described above, is the less desirable technique, because, first, increasing V-GATE for all the lesser performing pixels causes an increase in the overall power consumption of the active-matrix OLED flat-panel display. Second, decreasing the power is somewhat easier to implement in a signal processing system. Consequently, the second technique of decreasing V-GATE to match the lowest performing pixel is more desirable (assuming that the lowest performing pixel is performing at an acceptable brightness level). Therefore, an exemplary system and method for compensating the brightness of an active-matrix OLED flat-panel display is described in reference to FIGS. 3 through 6 according to this second technique. However, the system and method of the present invention are not limited to the second technique of decreasing V-GATE to match the lowest performing pixel. Alternatively, an average performing pixel or highest performing pixel may be selected as the reference and the V-GATE of all others adjusted accordingly.

FIG. 3 illustrates a functional block diagram of a brightness calibration system 300 for providing brightness uniformity within an active-matrix OLED flat-panel display in accordance with the invention. While the elements and operation of brightness calibration system 300 of the present invention are described in reference to calibrating an active-matrix OLED display, brightness calibration system 300 is suitable for use with other types of video displays, such as a liquid crystal display or plasma display, and, thus, the use of brightness calibration system 300 is not limited to only an active-matrix OLED display.

Brightness calibration system 300 includes an OLED display assembly 310 that further includes a display control circuit 312, an active-matrix display 314, and a DC power supply (DC P/S) 316; and a measurement circuit 318.

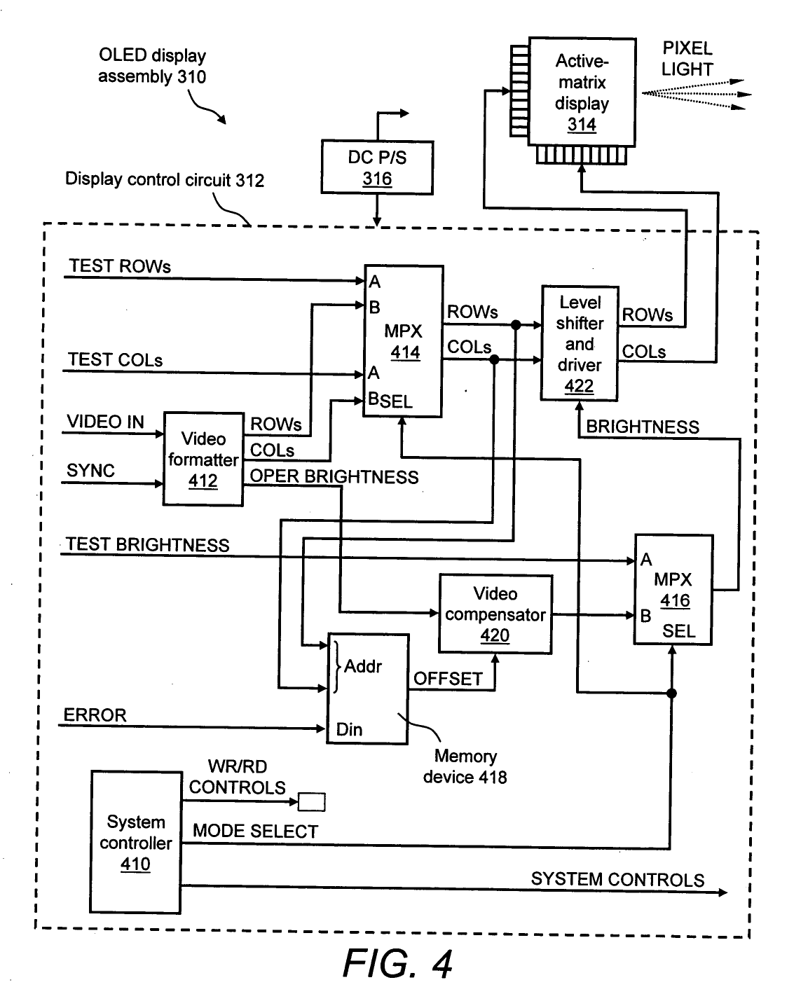

Display control circuit 312 and DC P/S 316 are built into the display interface circuitry of active-matrix display 314, which is representative of but not limited to a typical active-matrix OLED display under test. Display control circuit 312 is representative of the control logic for handling the operation of active-matrix display 314 and for interfacing with measurement circuit 318. DC P/S 316 is a standard DC power supply that supplies a voltage in the range of, for example, +3 to +20 volts to the electronic elements of OLED display assembly 310. More details of OLED display assembly 310 are found in reference to FIG. 4.

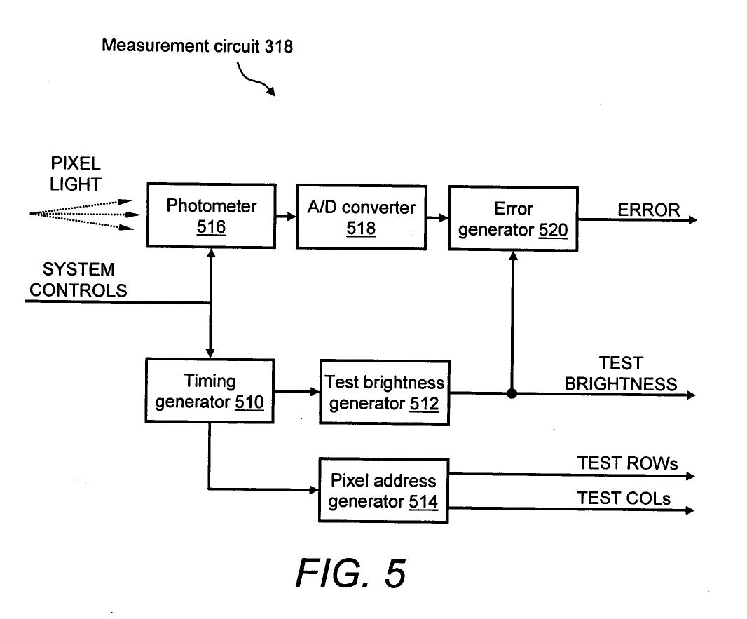

Measurement circuit 318 is representative of the control logic for handling a one-time brightness calibration operation of active-matrix display 314 of OLED display assembly 310, which, typically, occurs after initial fabrication and burn-in of OLED display assembly 310. After completion of the one-time brightness calibration operation, OLED display assembly 310 is separated from measurement circuit 318 and shipped to a user. More details of measurement circuit 318 are found in reference to FIG. 5.

FIG. 4 illustrates a functional block diagram of OLED display assembly 310 of brightness calibration system 300 of the present invention. OLED display assembly 310 includes display control circuit 312, active-matrix display 314, and DC P/S 316, as described in FIG. 3. However, FIG. 4 shows that display control circuit 312 further includes a system controller 410, a video formatter 412, a multiplexer (MPX) 414, an MPX 416, a memory device 418, a video compensator 420, and a level shifter and driver 422.

System controller 410 is representative of a standard microprocessor device, such as a Philips 8051 8-bit microcontroller or a Motorola 6816 16-bit microcontroller. Alternatively, system controller 410 is an external processor, such as a personal computer or networked computer. System controller 410 is loaded with software for managing the operation and communication functions of brightness calibration system 300. For example, system controller 410 manages the write and read operations of, for example, memory device 418 via write/read control signals (WRIRD CONTROLS). Furthermore, system controller 410 provides a mode select signal (MODE SELECT) for switching between a display mode (DISPLAY MODE) and a measurement mode (MEAS MODE). DISPLAY MODE is a mode setting of brightness calibration system 300 wherein active-matrix display 314 is in a normal operating mode and is, thus, receiving its picture and brightness information via typical video input signals. By contrast, MEAS MODE is a mode setting of brightness calibration system 300 wherein a brightness calibration operation is performed upon active-matrix display 314 via an alternative source of picture and brightness information that is generated by measurement circuit 318. The operation of brightness calibration system 300 in DISPLAY MODE and MEAS MODE is further described below. Furthermore, system controller 410 generates a set of control signals (SYSTEM CONTROLS) for managing the operation of display control circuit 312 and measurement circuit 318.

In DISPLAY MODE, video formatter 412 supplies the brightness and picture information to active-matrix display 314. More specifically, video formatter 412 receives a standard video input signal (VIDEO IN) and synchronization signal (SYNC) from a standard video source, such as a television (not shown), and generates a set of column and row address outputs as well as a digitized brightness value output (OPER BRIGHTNESS) for feeding active-matrix display 314.

MPX 414 and MPX 416 perform a standard 2-to-1 multiplexing function for steering row and column signals and brightness information, respectively, to active-matrix display 314 from either measurement circuit 318 (described in more detail in reference to FIG. 5) in MEAS MODE or, alternatively, from video formatter 412 in DISPLAY MODE. The inputs to MPX 414 are the row signals (TEST ROWs) and column signals (TEST COLs) from measurement circuit 318 and the row signals (ROWs) and column signals (COLs) from video formatter 412. The output of MPX 414 is a set of COLs and a set of pulsed ROWs. The inputs to MPX 416 are the digitized test brightness value (TEST BRIGHTNESS) from measurement circuit 318 and a digitized brightness value from video compensator 420. The output of MPX 416 is a digitized brightness value (BRIGHTNESS).

The ROWs and COLs from MPX 414 and the BRIGHTNESS output from MPX 416 feed the input of level shifter and driver 422. Level shifter and driver 422 shifts the ROWs to a predetermined analog voltage level and includes a set of drivers for driving the ROW inputs of active-matrix display 314. Additionally, level shifter and driver 422 shifts the COLs to an analog voltage level, according to the brightness information received upon the BRIGHTNESS input signal. Level shifter and driver 422 includes a set of drivers for driving the analog COLs to active-matrix display 314. The analog voltage levels of the COLs entering active-matrix display 314 determine the brightness level of each pixel within active-matrix display 314. With reference to FIG. 1, if active-matrix array 100 is a portion of active-matrix display 314, the ROWs of active-matrix display 314 are, for example, ROW A and ROW B of active-matrix array 100 and the COLs of active-matrix display 314 are, for example, COLUMN A and COLUMN B of active-matrix array 100.

A digitized error signal (ERROR) from measurement circuit 318 feeds the data inputs (Din) of memory device 418. The ROWs and COLs from MPX 414 feed the address inputs (Addr) of memory device 418. Memory device 418 is any commercially available, non-volatile readable/writable computer memory device, such as any standard non-volatile random access memory (RAM) device. The read/write operations of memory device 418 are controlled by WR/RD CONTROLS from system controller 410. Memory device 418 serves as local storage for the brightness measurement information specifically related to each pixel of active-matrix display 314. Consequently, the minimum storage capacity of memory device 418 is dependent on the number of pixels within active-matrix display 314, as memory device 418 must be suitably large to store a unique brightness value for every pixel and sub-pixel, i.e., red, green, and blue, within active-matrix display 314.

Video compensator 420 performs the arithmetic function of subtracting a digital brightness offset value (OFFSET) stored in memory device 418 from the digitized OPER BRIGHTNESS value.

Additionally, FIG. 4 shows that active-matrix display 314 generates a light output (PIXEL LIGHT) when activated.

FIG. 5 illustrates a functional block diagram of measurement circuit 318 of brightness calibration system 300 of the present invention. FIG. 5 shows that measurement circuit 318 further includes a timing generator 510, a test brightness generator 512, a pixel address generator 514, a photometer 516, an analog-to-digital (A/D) converter 518, and an error generator 520.

In MEAS MODE, timing generator 510 is a clock generator that supplies the main timing signals to test brightness generator 512 and pixel address generator 514 for clocking out a set of timed signals therefrom. More specifically, in MEAS MODE, pixel address generator 514 generates a set of row and column address outputs, TEST ROWs and TEST COLs, respectively, that are timed according to the clock from timing generator 510. Likewise, in MEAS MODE, test brightness generator 512 generates a digitized test brightness value, TEST BRIGHTNESS, for each unique column and row address generated by pixel address generator 514. The digitized TEST BRIGHTNESS output of test brightness generator 512 is timed according to the clock from timing generator 510. TEST ROWs and TEST COLs feed MPX 414 of display control circuit 312 and TEST BRIGHTNESS feeds MPX 416 of display control circuit 312. As a result, test brightness generator 512 and pixel address generator 514 are the brightness and picture information sources, respectively, for active-matrix display 314 in the MEAS MODE of operation.

Photometer 516 is a standard precision photometer device, which is a well-known instrument used to measure light intensity. Photometer 516 is capable of detecting and measuring alternately red, green, or blue light. An example photometer suitable for use in measurement circuit 318 is a PR-705/715 SpectraScan fast scanning spectroradiometer manufactured by Photo Research, Inc. (Chatsworth, Calif.). Photometer 516 is positioned in close proximity to active-matrix display 314, such that PIXEL LIGHT is directed toward and received by photometer 516. Subsequently, photometer 516 produces an analog voltage output that is proportional to the measured light intensity of PIXEL LIGHT, which is fed into A/D converter 518 for performing a well-known conversion function to convert the analog voltage measurement to a digitized voltage measurement value. A first input of error generator 520 is fed by the digital output of A/D converter 518 and a second input of error generator 520 is fed by TEST BRIGHTNESS, which is a digitized reference value from test brightness generator 512. Error generator 520 is a logic device that compares the digital values on its two inputs and calculates a digitized output, ERROR, which represents the difference between the light intensity measurement of photometer 516 and the TEST BRIGHTNESS value. ERROR subsequently feeds the data inputs of memory device 418 of display control circuit 312. Photometer 516 and timing generator 510 are fed by SYSTEM CONTROLS from system controller 410 of display control circuit 312, which are used to manage the operation thereof.

With continuing reference to FIGS. 1 through 5, the operation of brightness calibration system 300 to achieve brightness uniformity across all pixels within active-matrix display 314 is as follows. Active-matrix display 314 of OLED display assembly 310 and photometer 516 of measurement circuit 318 are placed in close proximity to one another in a completely darkened environment. Under the control of system controller 410, brightness calibration system 300 is switched to the MEAS MODE of operation, which places MPX 414 and MPX 416 in a state such that the source for the ROWs and COLs that feeds level shifter and driver 422 is pixel address generator 514 and the source for the brightness information that feeds level shifter and driver 422 is TEST BRIGHTNESS from test brightness generator 512. The value of TEST BRIGHTNESS is set by system controller 410 to a predetermined fixed value for the duration of the MEAS MODE operation. The digital value of TEST BRIGHTNESS corresponds to an analog voltage level. For example, TEST BRIGHTNESS may be set to +10 volts, which may correspond, for example, to a maximum brightness setting. Consequently, the analog voltage level of all COLs from level shifter and driver 422 that feed active-matrix display 314 are set according to TEST BRIGHTNESS.

Pixel address generator 514 supplies a unique row and column address, according to the location of a given pixel within active-matrix display 314. The TEST COLs are provided as a steady-state level, while the TEST ROWs are timed pulses. One measurement cycle is executed and, thus, the OLED of only one pixel is turned on. For example and with reference to FIG. 1, if active-matrix array 100 is a portion of active-matrix display 314, when a given ROW is pulsed, a given switch transistor 112 transfers the voltage level (corresponding to TEST BRIGHTNESS) present at a given COL select line to a given power transistor 114 and thereby turns on the selected OLED 118. The voltage level present at a given COL select line is also stored upon the corresponding capacitor 116. Having turned on the desired OLED 118, photometer 516 detects and measures the light intensity thereof. The light intensity measurement from photometer 516 is digitized via A/D converter 518 and then compared to the digitized TEST BRIGHTNESS by error generator 520, which generates ERROR, which represents the difference between the light intensity measurement of photometer 516 and the TEST BRIGHTNESS value. The digitized ERROR value is then stored within memory device 418.

In like manner, each pixel within active-matrix display 314 is activated sequentially and the light intensity of each pixel is measured one at a time, until the light intensity of all pixels has been measured and an associated ERROR value is stored within memory device 418. System controller 410 then reads the contents of memory device 418 and executes an algorithm to determine which pixel within active-matrix display 314 supplied the lowest output light intensity. The pixel associated with the lowest output light intensity is established as the reference pixel. Given that the relationship of the measured output light intensity to the value of TEST BRIGHTNESS is known, system controller 410 then executes an algorithm to calculate an amount by which the brightness value for all pixels, relative to the reference pixel, is reduced, and thereby creates an OFFSET value, which is representative of a voltage value that is, typically, in the order of a few millivolts for each pixel location. System controller 410 then overwrites the contents of memory device 418 with the calculated OFFSET value for each pixel location. It is noted that brightness calibration system 300 of the present invention is not limited to selecting the lowest performing pixel as the reference pixel. Alternatively, an average performing pixel or highest performing pixel may be selected as the reference and an OFFSET value determined accordingly.

Under the control of system controller 410, brightness calibration system 300 is then switched to the DISPLAY MODE of operation, which places MPX 414 and MPX 416 in a state such that the source for the ROWs, COLs, and brightness information that feeds level shifter and driver 422 is video formatter 412. When video formatter 412 is activated, picture and brightness information is received, according to the VIDEO IN and SYNC signals that enter video formatter 412. However, the digital value that represents the brightness information, i.e., OPER BRIGHTNESS, from video formatter 412 is adjusted by the OFFSET value from memory device 418 via video compensator 420, which performs an arithmetic function that provides an adjusted digital BRIGHTNESS value to level shifter and driver 422. Because memory device 418 is addressed by the ROWs and COLs, as is active-matrix display 314, the BRIGHTNESS adjustment operation of video compensator 420 occurs, in real time, pixel-by-pixel. Level shifter and driver 422 applies the adjusted BRIGHTNESS, which is an analog voltage that corresponds to the adjusted brightness level, to the COLs that feed active-matrix display 314. As a result, the brightness of each pixel within active-matrix display 314 is compensated, in real time, relative to the reference pixel, as determined in the MEAS MODE of operation. In this way, uniform brightness is achieved from pixel-to-pixel across the full array of active-matrix display 314.

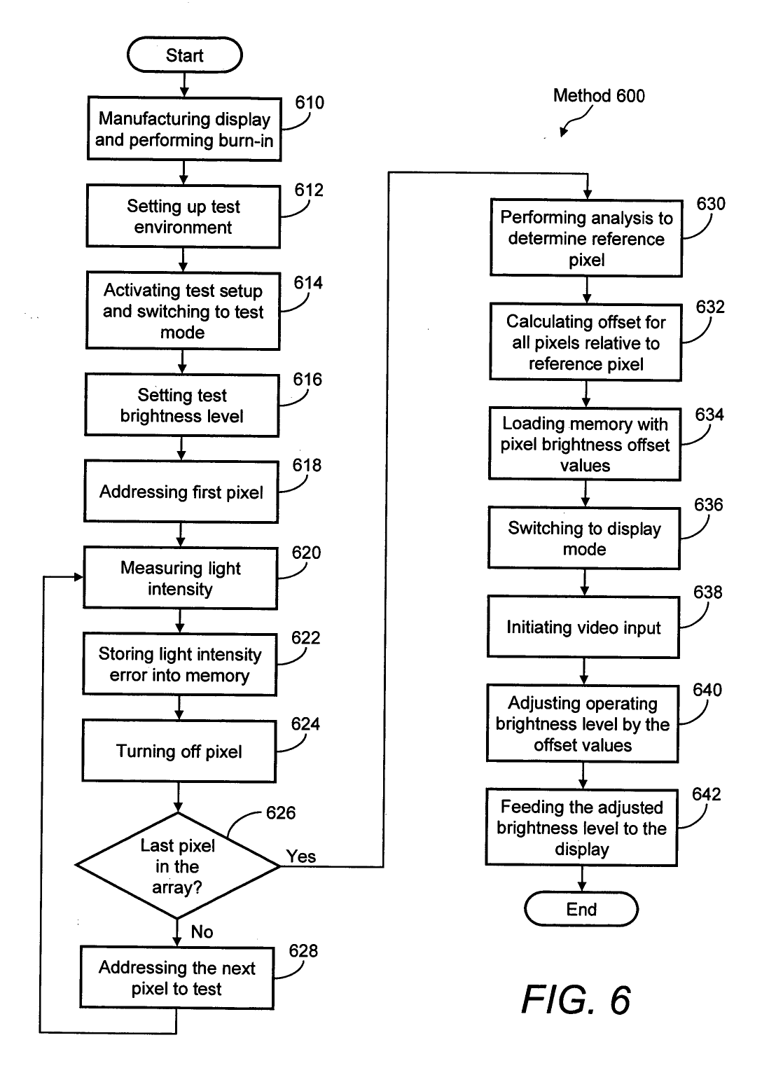

FIG. 6 illustrates a flow diagram of a method 600 of calibrating a video display to achieve uniform brightness by use of brightness calibration system 300 of the present invention. As an example, method 600 describes a method of calibrating OLED display assembly 310 that includes active-matrix display 314; however, method 600 is suitable for use with any type of video display. With continuing reference to FIGS. 1 through 5, method 600 includes the following steps.

At step 610, OLED display assembly 310 is manufactured, tested, and, subsequently, subjected to a standard burn-in cycle, which is a process used in semiconductor manufacturing that is designed to detect early failures of an electronic device, by subjecting the device to high-electric field stress at elevated temperature for a lengthy period of time.

At step 612, assuming no failures at step 610, OLED display assembly 310 and measurement circuit 318 are electrically and optically connected to form brightness calibration system 300. Furthermore, active-matrix display 314 of OLED display assembly 310 and photometer 516 of measurement circuit 318 are placed in close proximity to one another in a completely darkened environment.

At step 614, system controller 410 switches brightness calibration system 300 to the MEAS MODE of operation, which places MPX 414 and MPX 416 in a state such that the source for the ROWs and COLs that feeds level shifter and driver 422 is pixel address generator 514 and the source for the brightness information that feeds level shifter and driver 422 is TEST BRIGHTNESS from test brightness generator 512. System controller 410 executes a predetermined reset routine that turns off every pixel within active-matrix display 314.

At step 616, system controller 410 sets the value of TEST BRIGHTNESS from test brightness generator 512 to a predetermined fixed value for the duration of the MEAS MODE operation. The digital value of TEST BRIGHTNESS corresponds to an analog voltage value in the range of, for example, +2 to +15 volts. For example, TEST BRIGHTNESS may be set to +10 volts, which may correspond, for example, to a maximum brightness setting. Alternatively, TEST BRIGHTNESS may be set to any intermediate voltage level that corresponds to an intermediate brightness level. Consequently, the analog voltage level of all COLs from level shifter and driver 422 that feed active-matrix display 314 is set according to TEST BRIGHTNESS.

At step 618, pixel address generator 514 supplies a unique row and column address, according to the location of a given pixel within active-matrix display 314. The TEST COLs are provided as a steady-state level, while the TEST ROWs are provided as timed pulses. One cycle is executed and, thus, the OLED of only the first pixel is turned on.

At step 620, photometer 516 detects and measures the intensity of PIXEL LIGHT of the selected pixel. Photometer 516 produces an analog voltage output that is proportional to the measured light intensity of PIXEL LIGHT, which is fed into A/D converter 518.

At step 622, the light intensity measurement from photometer 516 is digitized via A/D converter 518 and compared to TEST BRIGHTNESS by error generator 520, which generates ERROR, which represents the difference between the light intensity measurement of photometer 516 and the TEST BRIGHTNESS value. The digitized ERROR value is then stored within memory device 418.

At step 624, system controller 410 turns off the pixel under test, either by turning off the individual pixel under test or by executing a predetermined reset routine that turns off every pixel within active-matrix display 314. Alternatively, the reset routine may be executed preceding a whole row or column of pixel tests.

At step 626, if system controller 410, in combination with pixel address generator 514, determines that the last pixel in the array has been activated and tested, method 600 proceeds to step 630. However, if system controller 410, in combination with pixel address generator 514, determines that the last pixel in the array has not yet been activated and tested, method 600 proceeds to step 628.

At step 628, pixel address generator 514 increments the row and/or column address and thereby selects the next pixel. Method 600 returns to step 620.

At step 630, system controller 410 performs an analysis to determine the least performing pixel, which then becomes the reference. More specifically, system controller 410 reads the contents of memory device 418 and executes an algorithm to determine which pixel within active-matrix display 314 supplied the lowest output light intensity. The pixel associated with the lowest output light intensity is established as the reference pixel. Alternatively, an average performing pixel or highest performing pixel may be selected as the reference and an OFFSET value determined accordingly at step 632.

At step 632, given that the relationship of the measured output light intensity to the value of TEST BRIGHTNESS is known, system controller 410 executes an algorithm to calculate an amount by which the brightness value for all pixels, relative to the reference pixel, is reduced and thereby creates an OFFSET value, which is representative of a voltage value that is, typically, in the order of a few millivolts for each pixel location.

At step 634, system controller 410 overwrites the contents of memory device 418 with the calculated OFFSET value for each pixel location, as calculated at step 632.

At step 636, system controller 410 switches brightness calibration system 300 to the DISPLAY MODE of operation, which places MPX 414 and MPX 416 in a state such that the source for the ROWs, COLs, and brightness information that feeds level shifter and driver 422 is video formatter 412.

At step 638, video formatter 412 is activated and, thus, its picture and brightness information are received, according to the VIDEO IN and SYNC signals that enter video formatter 412.

At step 640, the digital OPER BRIGHTNESS value from video formatter 412 is adjusted by the OFFSET value from memory device 418 via video compensator 420, which performs an arithmetic function that provides an adjusted digital BRIGHTNESS value to level shifter and driver 422. Because memory device 418 is addressed, in real time, by the ROWs and COLs, as is active-matrix display 314, the BRIGHTNESS adjustment operation of video compensator 420 occurs, in real time, pixel-by-pixel.

At step 642, level shifter and driver 422 applies the adjusted BRIGHTNESS, which is an analog voltage that corresponds to the adjusted brightness level, to the COLs that feed active-matrix display 314. As a result, the brightness of each pixel within active-matrix display 314 is compensated, in real time, relative to the reference pixel, as determined at step 630. In this way, the brightness from pixel-to-pixel across the full array of active-matrix display 314 is calibrated to a substantially uniform level.

Brightness calibration system 300 is not limited to the arrangement of elements shown in FIGS. 3, 4, and 5. Those skilled in the art will recognize that other arrangements of functional blocks and control logic are possible for forming brightness calibration system 300 without deviating from the essence and spirit of the invention. With reference to FIG. 3 through 6, other example embodiments are as follows.

In an alternative embodiment, a second memory device may be provided to store the OFFSET values, which allows the calculated ERROR values to remain stored in memory device 418.

In another alternative embodiment, error generator 520 is eliminated from measurement circuit 318. Instead, the digitized output of A/D converter 518 is stored directly within memory device 418. An algorithm is then executed by system controller 410 to read the contents of memory device 418, calculate the difference between the light intensity measurement of photometer 516 and the TEST BRIGHTNESS value, determine the reference pixel, calculate an OFFSET value for each pixel, and overwrite the contents of memory device 418 with the calculated OFFSET value for each pixel location.

In yet another alternative embodiment, instead of a single photometer 516 that handles red, green, and blue sub-pixels, there are multiple photometers 516 within measurement circuit 318. More specifically, there is a first dedicated photometer 516 and A/D converter 518 for use when calibrating any red sub-pixel, a second dedicated photometer 516 and A/D converter 518 for use when calibrating any green sub-pixel, a third dedicated photometer 516 and A/D converter 518 for use when calibrating any blue sub-pixel, and so on, for any color sub-pixel.

In yet another alternative embodiment, the corrective sequence of method 600 may be executed at various TEST BRIGHTNESS levels, as desired. For example, method 600 may be executed at a predetermined maximum TEST BRIGHTNESS level, then at a predetermined intermediate TEST BRIGHTNESS level, then at a predetermined minimum TEST BRIGHTNESS level. An OFFSET value is calculated and stored for each pixel for each TEST BRIGHTNESS level. The maximum, intermediate, and minimum OFFSET values for each pixel may all be stored in memory device 418 or, alternatively, may be stored in separate memory devices. Additionally, in DISPLAY MODE, video compensator 420 is capable of detecting the OPER BRIGHTNESS level received from video formatter 412, in real time, and determining whether it most closely matches the maximum, intermediate, or minimum TEST BRIGHTNESS level. Video compensator 420, which has access to the stored maximum, intermediate, and minimum OFFSET values, subsequently selects, in real time, the desired set of OFFSET values for generating an adjusted BRIGHTNESS output for each pixel. Furthermore, instead of a single video compensator 420 for handling multiple sets of OFFSET values, display control circuit 312 may include a separate video compensator 420 for each set of OFFSET values, the selection thereof controlled by system controller 410.

In all embodiments disclosed herein, the test time in MEAS MODE may be approximated as follows. Using an example of a 1000×2000 pixel array, there are two million pixels, multiplied by three colors and, thus, six million pixels to be measured. Six million, multiplied by the line time, which is, for example, 70 μS, yields a test time of 6,000,000×70 μS=420 seconds=7 minutes.

In DISPLAY MODE, the embodiment of brightness calibration system 300 described in FIGS. 3, 4, and 5, within which video compensator 420 is fed by a single OFFSET signal for adjusting the brightness of each sub-pixel one at a time, results in a given sub-pixel address time, t, that is dependent on the size of the pixel array, i.e., the total number of sub-pixels within active-matrix display 314. However, those skilled in the art will recognize that the sub-pixel address time may be increased proportionately by use of a multiple parallel path design. For example, two groups of three single-color pixels (or three groups of two single-color pixels) are addressed in parallel, which results in a sub-pixel address time of 6×t. In this example, video compensator 420 is fed by six OFFSET signals from six memory devices 418, respectively.

The above description and drawings illustrate embodiments which achieve the objects of the present invention. Although certain advantages and embodiments have been described above, those skilled in the art will recognize that substitutions, additions, deletions, modifications and/or other changes may be made without departing from the spirit or scope of the invention. Accordingly, the invention is not limited by the foregoing description but is only limited by the scope of the appended claims.

What is claimed as new and desired to be protected by Letters Patent of the United States is:

1. A brightness compensation system for a video display, comprising:
a video display having a plurality of pixels;
a controller for controlling operation of the video display in a plurality of modes including a display mode and a test mode, wherein, in said test mode, a brightness output by each of said plurality of pixels is measured and compared with a test brightness value, said controller choosing one of said plurality of pixels as a reference pixel and determining offset values for each of said plurality of pixels, wherein said offset values represent the difference in brightness output by each of said plurality of pixels and said reference pixel;
a memory for storing said offset values for each of said plurality of pixels; and
a compensator for providing, in said display mode, an adjusted brightness value to each of said plurality of pixels based on said offset values.

2. The system of claim 1, wherein said reference pixel is a pixel having the lowest brightness value.

3. The system of claim 1, wherein said reference pixel is a pixel having the highest brightness value.

4. The system of claim 1, wherein said reference pixel is a pixel having an average brightness value.

5. The system of claim 1, wherein said video display is an organic light-emitting diode display.

6. A method of setting brightness uniformity in a video display system, the method comprising:
switching said system into a test mode;
setting a test brightness level;
measuring brightness values output by each of a plurality of pixels of said video display with respect to said test brightness level;
comparing said measured brightness values to determine a reference pixel having a reference brightness value;
determining offset values for each of said plurality of pixels, wherein said offset values represent the difference between said brightness values for each of said plurality of pixels and said reference brightness value of said reference pixel;
loading said offset values into a memory device;
switching said system to a display mode; and
adjusting the brightness of each of said plurality of pixels by the respective offset values.

7. The method of claim 6, wherein said step of determining said reference pixel having said reference brightness value comprises determining a pixel having the lowest brightness value.

8. The method of claim 6, wherein said step of determining said reference pixel having said reference brightness value comprises determining a pixel having the highest brightness value.

9. The method of claim 6, wherein said step of determining said reference pixel having said reference brightness value comprises determining a pixel having an average brightness value.

10. A measurement circuit for a video display brightness compensation system, said circuit comprising:
a test brightness generator for supplying a test brightness signal to each of a plurality of pixels of a video display;
a photometer for measuring brightness output from each of said plurality of pixels of said video display in response to the application of said test brightness signal, said photometer providing an output of measured brightness; and
a logic device for receiving and comparing said output of measured brightness and said test brightness signal for each of said plurality of pixels to provide a corresponding output signal representing the difference between said output of measured brightness and said test signal for each pixel.

11. The system of claim 10, wherein said video display is an organic light-emitting diode display.

12. The system of claim 10, further comprising:
a controller for controlling operation of the video display compensation system in a plurality of modes including a display mode and a test mode, wherein, in said test mode, said brightness output by each of said plurality of pixels is measured and compared with said test brightness signal, said controller choosing one of said plurality of pixels as a reference pixel based on the output of said logical device and determining offset values for each of said plurality of pixels, wherein said offset values represent the difference in brightness output by each of said plurality of pixels and said reference pixel;
a memory for storing said offset values for each of said plurality of pixels; and
a compensator for providing, in said display mode, an adjusted brightness value to each of said plurality of pixels based on said offset values.

13. The system of claim 12, wherein said reference pixel is a pixel having the lowest brightness value.

14. The system of claim 12, wherein said reference pixel is a pixel having the highest brightness value.

15. The system of claim 12, wherein said reference pixel is a pixel having an average brightness value.

16. The system of claim 12, wherein said video display is an organic light-emitting diode display.
